(19) United States
(12) Patent Application Publication
(10) Pub. No.: US 2015/0113036 A1
(43) Pub. Date: Apr. 23, 2015

(54) SERVER AND METHOD FOR SHARING APPLICATION SERVICES

(71) Applicant: POWER-ALL NETWORKS LIMITED, Shatin (HK)

(72) Inventors: STEVE LAP WAI HUI, Shatin (HK); MENG-MING HUANG, Shenzhen (CN); JUN LV, Shenzhen (CN); LIN-RONG CHEN, Shenzhen (CN)

(21) Appl. No.: 14/491,497

(22) Filed: Sep. 19, 2014

(30) Foreign Application Priority Data
Oct. 18, 2013 (CN) 2013104916915

(51) Int. Cl. H04L 29/08

(52) U.S. Cl. CPC H04L 67/10
USPC 709/201

(57) ABSTRACT

An application service sharing method is applied between at least two servers. Each server includes an agent platform, a VFOS, and at least one application managing unit. The method includes the following steps of providing a user interface displaying all application services provided by one server, for an authorized user of another server which requests to share application services from the server to select at least one application service to be shared. Generating a shared resource having the selected application service, and generating registered information of the shared resource comprising a URL address and authentication information. Transmitting the registered information of the shared resource to the server which requests to share application services.

This application is related to co-pending U.S. patent application entitled, “SERVER AND METHOD FOR MANAGING APPLICATION SERVICES”, filed ______ (Atty. Docket No. US54181). The application has the same assignee as the present application. The above-indentified application is incorporated herein by reference.

### FIELD

The present disclosure relates to cloud computing, and particularly to a server capable of sharing application services, and a method for sharing application services.

### BACKGROUND

Cloud computing can be defined as a computer network which includes a server or servers connected through a communication network. Many application service providers are planning to enter the cloud computing market. Any individual user with permission to access the server can use the server to access a variety of application services provided by the application service providers, such as application programs, data storage, or other computing tasks.

### BRIEF DESCRIPTION OF THE DRAWINGS

Implementations of the present technology will be described, by way of example only, with reference to the attached figures.

FIG. 1 is a block diagram of an embodiment of a server including an application service provider (ASP) managing platform system.

FIG. 2 is a block diagram of two ASP managing platform systems of FIG. 1, which share application services with each other.

FIG. 3 is a block diagram of an embodiment of an VFOS included in the ASP managing platform system of FIG. 1.

FIG. 4 is a flowchart of an embodiment of a method for sharing application services.

FIG. 5 is a sub-flowchart after block 47 of the method of FIG. 4.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be made to function without these specific details. In other instances, methods, procedures, and components have not been described in detail so as not to obscure the feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure follow.

The term “comprising,” means “including, but not necessarily limited to” and specifically indicates open-ended inclusion or membership in a combination, group, series, or the like.

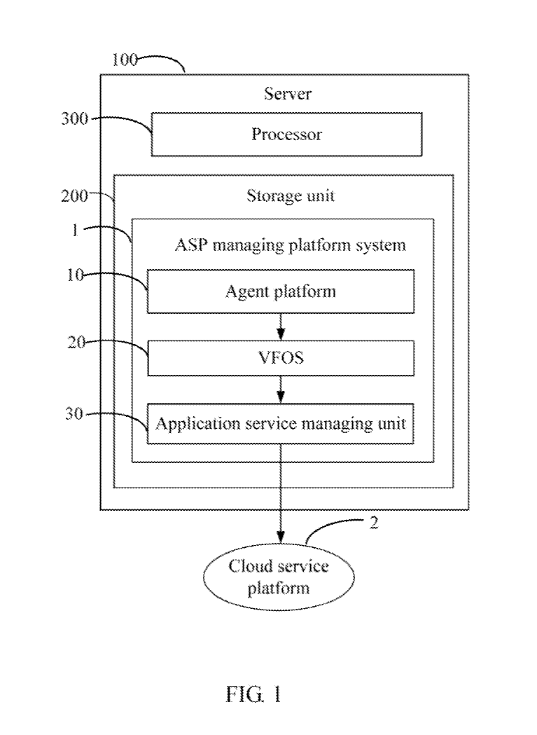

FIG. 1 is a block diagram of an embodiment of a server 100. The server 100 includes a storage unit 200 and a processor 300. The storage unit 200 stores an ASP managing platform system 1. The system 1 includes an agent platform 10, a virtual facilities operating system (VFOS) 20, and at least one application service managing unit 30. The agent platform 10 can be a commercial network having a uniform resource locator (URL) address.

Each application service managing unit 30 includes at least one application programming interface (API, not shown) each connected to one corresponding cloud service platform 2. Thus, each application service managing unit 30 can obtain application services from each connected cloud service platform 2 by a call to the corresponding API, and then manage the obtained application services. In at least one embodiment, the application services are application programs, data storage, or other computing tasks.

The VFOS 20 is connected to each application service managing unit 30, and adds the application services of each application service managing unit 30 to an application service pool.

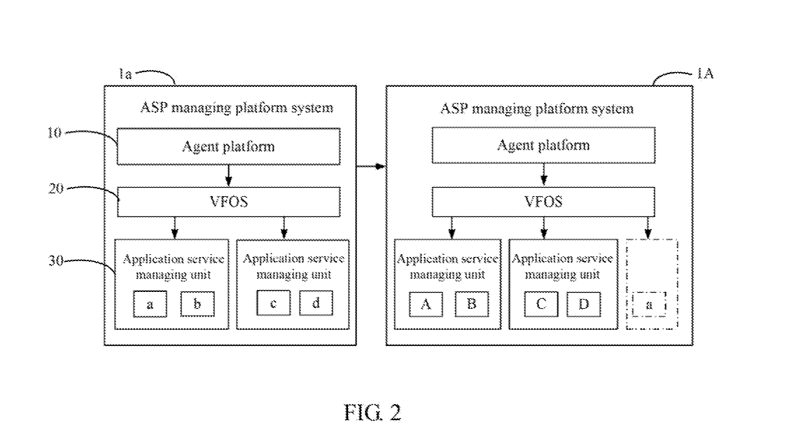

The agent platform 10 is connected to the VFOS 20, and generates an application service list including information of the application services added to the application service pool, to allow users to purchase any application service included in the application service list via the agent platform 10. For example, as shown in FIG. 2, the system 1a includes application services a, b, c, and d. Thus, the agent platform 10 can generate the application service list including the information of the application services a, b, c, and d. In at least one embodiment, the information of an application service includes the name, the price, and the brief introduction of the application service.

FIG. 2 illustrates two systems 1A and 1a which respectively manage application services provided by different ASPs, and can share application services. It is notable that the number of the systems is not limited, and can be varied according to need.

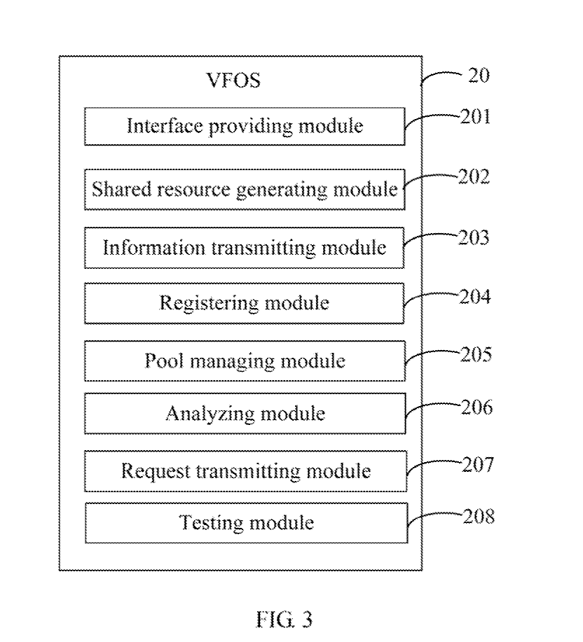

The VFOS 20 include a variety of modules as a collection of software instructions executable by the processor 300 to provide the function of the VFOS 20. Referring also to FIG. 3, the VFOS 20 includes an interface providing module 201, a shared resource generating module 202, an information transmitting module 203, a registering module 204, and a pool managing module 205. A detail description of the variety of modules will be described as follows by assuming that the system 1A (requesting system) requests to share an application service “a” from the system 1a (requested system).

The interface providing module 201 of the system 1a provides a user interface displaying all application services provided by the system 1a, for an authorized user (such as the administrator for example) of the system 1A to select at least one application service (i.e., the application service “a” in this embodiment) to be shared.

The shared resource generating module 202 of the system 1a generates a shared resource including the selected application service, and generates registered information of the shared resource. The registered information includes the URL address and the authentication information of the shared resource.

The information transmitting module 203 of the system 1a transmits the registered information of the shared resource to the system 1A. For example, the information transmitting module 203 can transmit a short message including the registered information to the cell phone of the authorized user of the system 1A.

The registering module 204 of the system 1A provides a registered interface for the authorized user of the system 1A to input the registered information including the URL address and authorization information of the shared resource, after receiving the registered information from the system 1a, and determines whether the authorized user of the system 1A is authorized to access the shared resource according to the input authorization information. If so, the registering module 204 further records the URL address of the shared resource included in the registered information.

The pool managing module 205 of the system 1A obtains the application services of the shared resource according to the recorded URL address of the shared resource, and adds the application services of the shared resource to the application service pool of the system 1A. Thus, the selected application service “a” originally provided by the system 1 a are added to the application service pool of the system 1A.

As described above, the agent platform 10 of the system 1A can update the application service list including the application service “a” added to the application services pool. Therefore, the users of the system 1A can purchase the application service “a” originally provided by the system 1a, via the agent platform 10 of the system 1A.

In at least one embodiment, the agent platform 10 periodically (such as every four hours for example) checks the application services included in the application service pool, and updates the application service list each time a new application service is added to the application service pool.

In at least one embodiment, the VFOS 20 further includes an analyzing module 206 and a request transmitting module 207. When a user selects to purchase at least one application service on the application service list, the agent platform 10 generates a request including information of the application service to be purchased, and transmits the request to the VFOS 20.

The analyzing module 206 determines the corresponding application service managing unit 30 which provides the application service to be purchased according to the request received from the agent platform 10. The request transmitting module 207 transmits the request to the determined application service managing unit 30. Then, the determined application service managing unit 30 generates an order which directs the corresponding cloud service platform 2 to set up or run the application service to be purchased. Such a method for determining the corresponding application service managing unit and the corresponding cloud service platform 2 is known in the subject matter of the co-pending application US54181.

In at least one embodiment, when the analyzing module 206 of the system 1A determines that the application service to be purchased is included in the shared resource, that is, the application service managing unit 30 which provides the application service to be purchased is in the system 1a, the request transmitting module 207 of the system 1A transmits the request to the application service managing unit 30 corresponding to the shared resource via the record website of the shared resource.

In at least one embodiment, the VFOS 20 further includes a testing module 208. When the registering module 204 records the URL address of the shared resource, the testing module 208 tests whether the VFOS 20 can communicate with the application service managing unit 30 corresponding to the shared resource according to the URL address of the shared resource, and determines whether the URL address of the shared resource is correctly recorded according to the tested result.

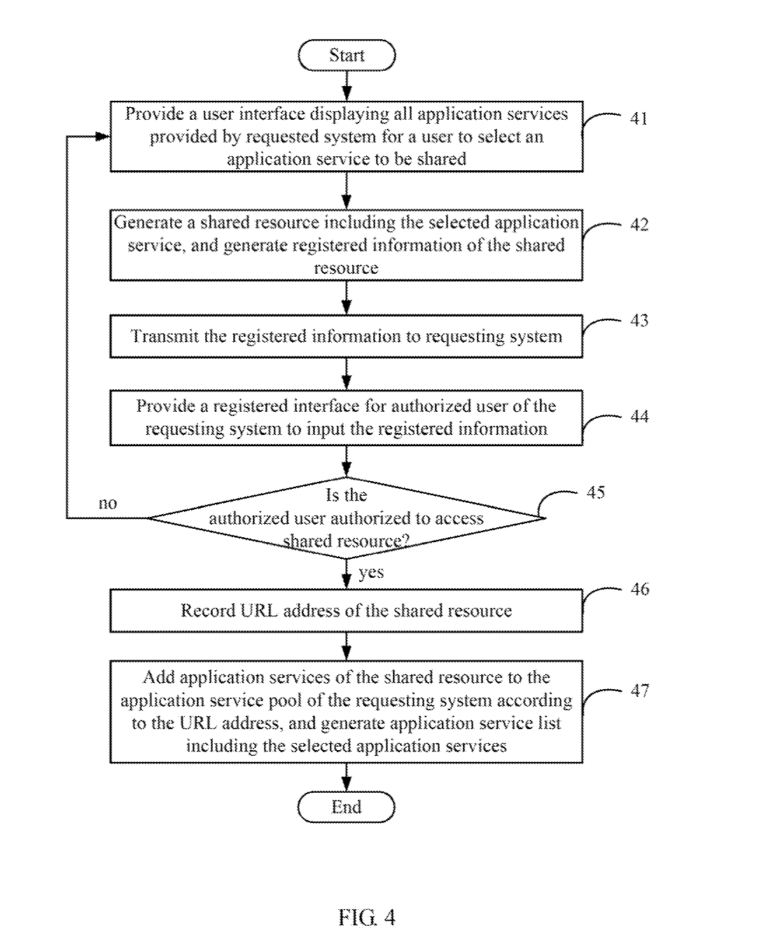

FIG. 4 is a flowchart of an embodiment of a method for sharing application resources between a requesting ASP managing platform system and a requested ASP managing platform system. Each of the systems includes an agent platform and at least one application service managing unit.

In block 41, an interface providing module of the requested system provides a user interface displaying all application services provided by the requested system, for a user of the requesting system to select at least one application service to be shared.

In block 42, a shared resource generating module of the requested system generates a shared resource including the selected application service, and generates registered information of the shared resource. The registered information includes the URL address and the authentication information of the shared resource.

In block 43, an information transmitting module of the requested system transmits the registered information of the shared resource to the requesting system.

In block 44, a registering module of the requesting system provides a registered interface for an authorized user of the requesting system to input the registered information including the URL address and authorization information of the shared resource.

In block 45, the registering module of the requesting system determines whether the authorized user of the requesting system is authorized to access the shared resource according to the input authorized information, if yes, the procedure goes to block 46; otherwise, block 41 is repeated.

In block 46, the registering module records the URL address of the shared resource included in the registered information.

In block 47, a pool managing module of the requesting system adds the application services of the shared resource to the application service pool of the requesting system according to the recorded URL address of the shared resource. Therefore, an agent platform of the requesting system can update the application service list including the selected application services added to the application services pool.

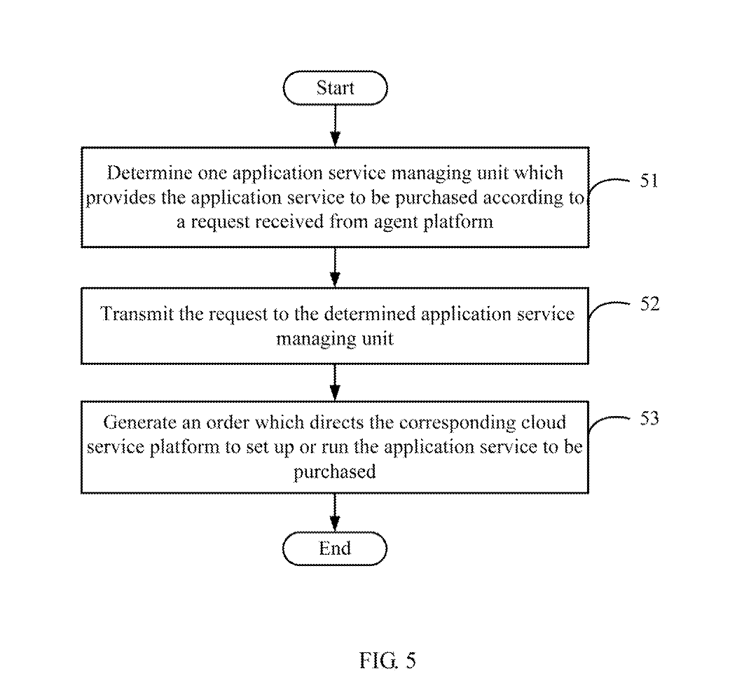

FIG. 5 is a sub-flowchart after block 47 of the method of FIG. 4.

In block 51, an analyzing module determines the application service managing unit which provides the application service to be purchased according to the request received from the agent platform.

In block 52, a request transmitting module transmits the request to the determined application service managing unit.

In block 53, the determined application service managing unit generates an order which directs the corresponding cloud service platform to set up or run the application service to be purchased.

The described embodiments and their advantages will be understood from the foregoing description. It will be apparent that various changes may be made thereto without departing from the scope of the disclosure or sacrificing all of its material advantages, the examples described merely being exemplary embodiments of the present disclosure. The described embodiments are not intended to limit the scope of the following claims.

What is claimed is:

1. A server comprising:
a storage unit storing:
at least one application service managing unit each connected to at least one cloud service platform to obtain application services provided by the cloud service platform;
a virtual facilities operating system (VFOS) comprising a plurality of modules to add application services of each application service managing unit to an application service pool; and
an agent platform to generate an application service list having information of the application services added to the application service pool; and
a processor to execute the plurality of modules of the VFOS;
wherein the plurality of modules comprise:
an interface providing module to provide a user interface displaying all application services provided by the server for an authorized user of another server which requests to share application services from the server to select at least one application service to be shared;
a shared resource generating module to generate a shared resource having the selected application service, and generate registered information of the shared resource comprising a URL address and authentication information; and
an information transmitting module to transmit the registered information of the shared resource to the server which requests to share application services.

2. The server of claim 1, wherein the information of an application service comprising a name, a price, and a brief introduction of the application service.

3. The server of claim 1, wherein the plurality of modules further comprises a registering module and a pool managing module; the registering module is configured to provide a registered interface for the authorized user to input the registered information after receiving the registered information, and record the URL address of the shared resource comprised in the registered information when determining that the authorized user is authorized to access the shared resource; the pool managing module is configured to add application services of the shared resource to the application service pool according to the recorded URL address of the shared resource, thereby allowing the agent platform to update the application service list having the selected application service added to the application services pool.

4. The server of claim 3, wherein the agent platform is configured to periodically check the application services added to the application service pool, and update the application service list each time a new application service is added to the application service pool.

5. The server of claim 3, wherein the plurality of modules further comprises an analyzing module and a request transmitting module; the analyzing module is configured to determine one application service managing unit which provides the application service to be purchased according to a request received from the agent platform; the request transmitting module is configured to transmit the request to the determined application service managing unit; the determined application service managing unit generates an order which directs the corresponding cloud service platform to set up or run the application service to be purchased.

6. The server of claim 5, wherein when the application service to be purchased is comprised in the shared resource, the request transmitting module is configured to transmit the request to an application service managing unit corresponding to the shared resource via the record website of the shared resource.

7. The server of claim 3, wherein the plurality of modules further comprises a testing module; when the registering module records the URL address of the shared resource, the testing module is configured to test whether the VFOS is able to communicate with the application service managing unit corresponding to the shared resource according to the URL address of the shared resource, and determine whether the URL address of the shared resource is correctly recorded according to the tested result.

8. A method for sharing application services applied between at least two servers, each server comprising an agent platform, a virtual facilities operating system (VFOS), and at least one application managing unit, each application service managing unit connected to at least one cloud service platform to obtain application services provided by the cloud service platform, the VFOS configured to add the application services of each application service managing unit to an application service pool, the agent platform configured to generate an application service list having information of the application services added to the application service pool, the method comprising:
providing a user interface displaying all application services provided by one server, for an authorized user of another server which requests to share application services from the server to select at least one application service to be shared;
generating a shared resource having the selected application service, and generating registered information of the shared resource comprising a URL address and authentication information; and
transmitting the registered information of the shared resource to the server which requests to share application services.

9. The method of claim 8 further comprising:
providing a registered interface for the authorized user to input the registered information after receiving the registered information;
recording the URL address of the shared resource comprised in the registered information when determining that the authorized user is authorized to access the shared resource; and
adding application services of the shared resource to the application service pool according to the recorded URL address of the shared resource, thereby allowing the agent platform to update the application service list having the selected application service added to the application services pool.

10. The method of claim 9 further comprising:
determining one application service managing unit which provides the application service to be purchased according to a request received from the agent platform;
transmitting the request to the determined application service managing unit; and
generating an order by the determined application service managing unit which directs the corresponding cloud service platform to set up or run the application service to be purchased.
